(19) United States
(12) Patent Application Publication
(10) Pub. No.: US 2006/0256511 A1
(43) Pub. Date: Nov. 16, 2006

(54) Tablet computer stander apparatus with keyboard room space thereof

(76) Inventor: Yan-Bin Ma, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/213,684

(22) Filed: Aug. 30, 2005

(30) Foreign Application Priority Data
May 12, 2005 (TW) 094207665

(51) Int. Cl. G06F 1/16

(52) U.S. Cl. 361/680

(57) ABSTRACT

A tablet computer stander apparatus with a keyboard room space is often used in portable computer apparatus like tablet computer. The tablet computer stander apparatus often comprises a tablet computer pivot structure and a keyboard store structure. This tablet computer pivot structure provides the computer host to pivot stander apparatus, and the computer host is able to stand on the outside surface of the keyboard store cases; moreover, the keyboard can be pulled out from the inside of the keyboard store case so as users can type the keyboard to control the computer host.

### FIELD OF THE INVENTION

The present invention relates to stander apparatus with keyboard room space of a tablet computer, in particular, a tablet computer structure comprising a hinge structure and a spacing structure for keyboard storage.

### BACKGROUND OF THE INVENTION

As demands for relying upon the computer apparatus as tools, the mainstream of computer apparatus is dominated by the tablet computer instead of the desktop computer apparatus.

The first priority function of tablet computers is easy carrying. Therefore, many methods to minify the equipments corresponding to tablet computers are invented recently. Referred to FIG. 1, illustrates a method in the prior art by using a tablet screen to replace the keyboard means. In FIG. 1, the tablet computer main body 11 of the tablet computer includes a tablet screen displaying structure 111, wherein the tablet computer is operated by using a stylus pen 12 for inputting coordinate data on the tablet screen displaying structure 111.

However, in actual markets, people are still used to operating computers with a typing apparatus for inputting data. Therefore, it necessitates including the keyboard in the list of the basic equipments of a tablet computer. FIG. 2, FIG. 3 and FIG. 4 are the perspective views of a tablet computer equipped with a keyboard for dissecting, assembling, and operating purposes respectively. In FIG. 2, a tablet computer main body 11 is coupled with a keyboard structure 22 by a hinge structure 21 so that the tablet computer main body 11 can be in a state of an operating mode of the keyboard structure 22 represented in FIG. 3 or a state wherein a tablet computer main body 11 is coupled with a keyboard structure 22 by a hinge structure 21 so that the tablet computer main body 11 can rotate with a 180° angle. The back surface of the tablet computer main body 11 and the upper surface of the keyboard structure 22 face each other as represented in FIG. 4 operating with a stylus pen 12.

As mentioned above, the hinge structure 21 not only provides the coupling function for the tablet computer main body 11 and the keyboard structure 22, but also provides the rotating function shown in FIG. 3 and the overlaying function represented in FIG. 4 after the 180° rotation. Generally, the hinge structure is a design with complex mechanisms.

Furthermore, the operations by the 180° rotation of the tablet computer main body 11 represented in FIG. 3 being in a mode represented in FIG. 4 operating with a stylus pen 12 cause the electrical connection between the tablet computer main body 11 and the keyboard structure 22 to be easily broken due to frequently twists.

Additional objects and advantages of the invention for a tablet computer stander apparatus with a keyboard room space thereof make easier the coupling between the tablet computer main body and the keyboard structure and avoid the damage of the electrical connection between the tablet computer main body and the keyboard structure due to frequently twist, too.

### SUMMARY OF THE INVENTION

It is an object of the present invention for a tablet computer apparatus to provide a tablet computer main body for operating with the displaying structure of a tablet screen and to provide a keyboard storage case coupled with the main body of the tablet computer, wherein the keyboard can be pulled out of the keyboard storage case so as to operate the tablet computer with the keyboard. According to the present invention, there is also provided a solution to solve the damage problem of the electrical connection between the tablet computer main body and the keyboard due to frequently twists.

According to another aspect of the present invention, a tablet computer apparatus comprises: a tablet computer main body coupled with a keyboard storage case by a hinge structure comprising a hinge component fixed on one surface of the keyboard storage case, a lock structure, e.g. a screw nut, screwed by hands for settling the tablet computer main body, wherein the tablet computer main body can rotate by the means of the coupling structure corresponding to the keyboard storage case.

Other features and advantages of the present invention will become apparent from the following detailed description when read in conjunction with the drawings, and from the appended claims.

### BRIEF DESCRIPTION OF THE DRAWINGS

FIG. 1 is a perspective view of the tablet computer main body in the prior art;

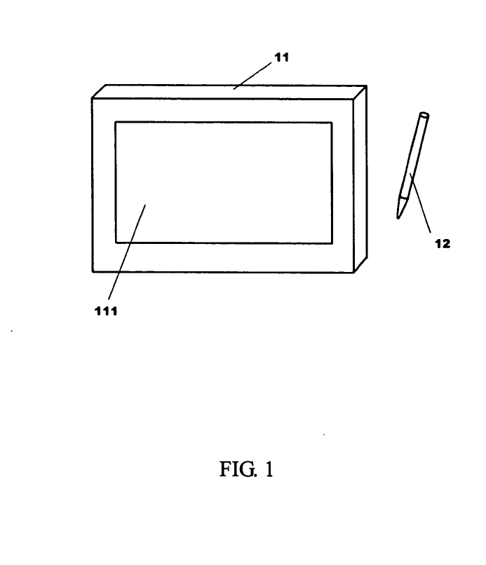

FIG. 2 is a dissection view of the tablet computer main body coupled with a keyboard structure by a coupling structure;

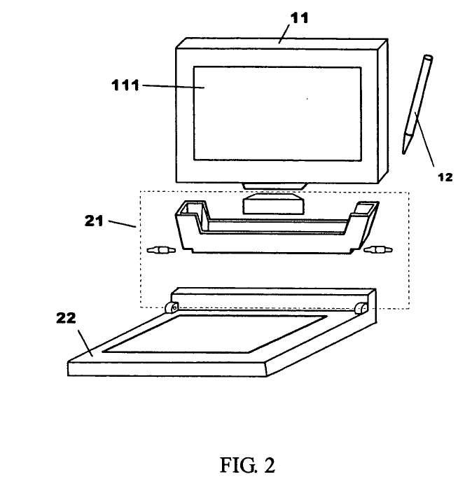

FIG. 3 is an assembling view of the tablet computer main body coupled with a keyboard structure by a coupling structure;

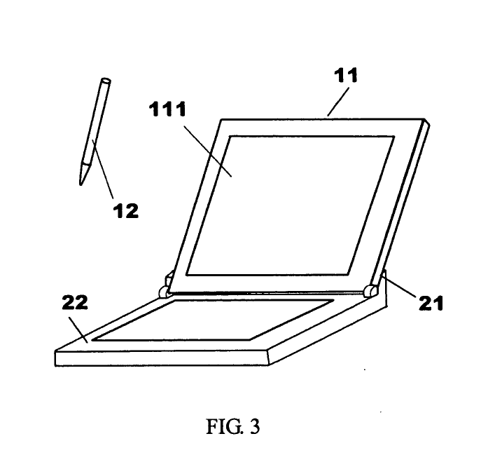

FIG. 4 is an operating view of the tablet computer main body coupled with a keyboard structure by a coupling structure;

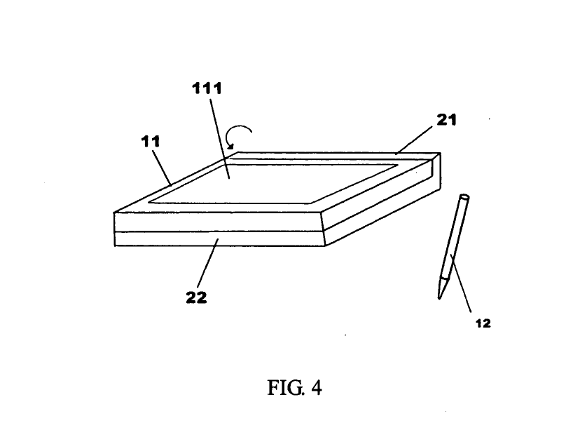

FIG. 5 is a perspective view of a preferred embodiment according to the present invention operating the tablet computer by using a stylus pen for inputting data into the tablet computer main body;

FIG. 6 is a perspective view of another preferred embodiment according to the present invention utilizing a hinge structure coupling the tablet computer main body with the keyboard storage case wherein a keyboard can be pulled out from the keyboard storage case and be operated to control the tablet computer;

FIG. 7 is a perspective view of the keyboard storage case according to the present invention;

FIG. 8 is another perspective view of the keyboard storage case stocking a keyboard;

FIG. 9 is a further perspective view of the tablet computer apparatus utilizing the hinge structure coupling the tablet computer main body with the keyboard storage case; and

FIG. 10 is a perspective view of the electrical connection coupling the hinge structure with the keyboard storage structure.

### DETAILED DESCRIPTION OF THE PREFERRED EMBODIMENTS

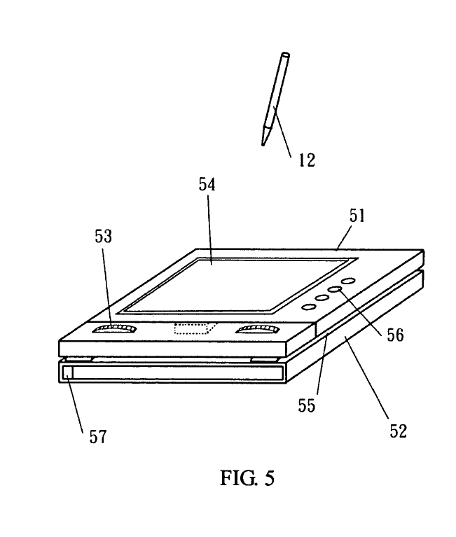

Referred to FIG. 5, shows the operating mode of the tablet computer apparatus utilizing the stylus pen for inputting coordinate data on the tablet to control the processing unit of the computer. The computer comprises a tablet computer main body 51 overlapping on one covering surface 55 of the keyboard storage case 52 controlled by a stylus pen 12 for inputting data on the touch screen 54 or at least one control key 56 positioned around the touch screen 54 wherein the tablet computer main body 51 is coupled with the keyboard storage case 52 by a hinge structure 53. Furthermore, the keyboard storage case 52 not only stocking a keyboard but also a push rod structure 57, wherein the keyboard can be pulled out by pressing the push rod structure 57.

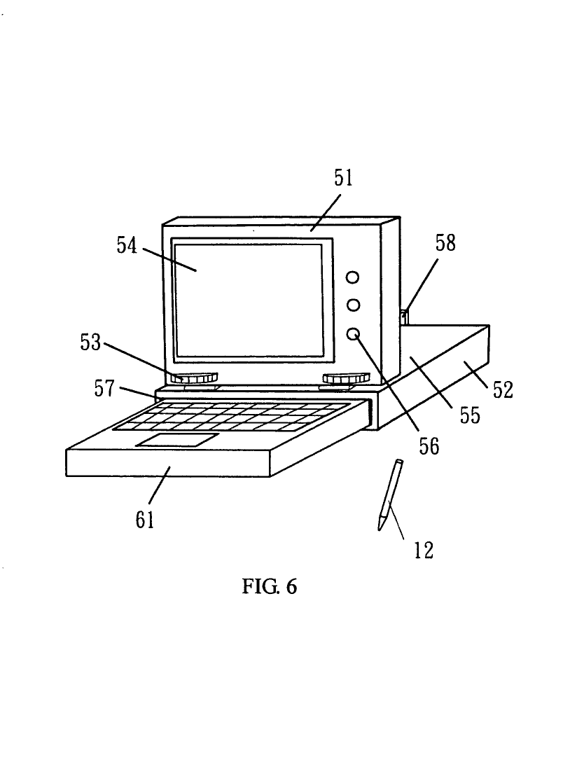

As mentioned in FIG. 5, despite utilizing the stylus pen 12 for inputting coordinate data on the touch screen 54 to operate the tablet computer main body 51, there is provided another operating mode by utilizing the keyboard. In FIG. 6, the hinge structure 53 provides the tablet computer main body 51 to be pivotal to a state, wherein the tablet computer main body 51 stands up on the covering surface 55 of the keyboard storage case 52. The keyboard 61 can be pulled out by pressing the push rod 57 for inputting instructions to control the tablet computer main body 51. Meanwhile, the stylus pen 12 can still input coordinate data on the touch screen 54 to control the tablet computer main body 51, wherein the tablet computer main body 51 is from a state wherein the tablet computer main body 51 is latched by a lock structure 58 to a state wherein the tablet computer main body 51 stands on the keyboard storage case 52.

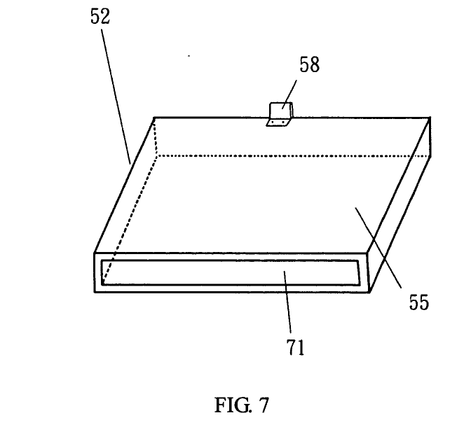

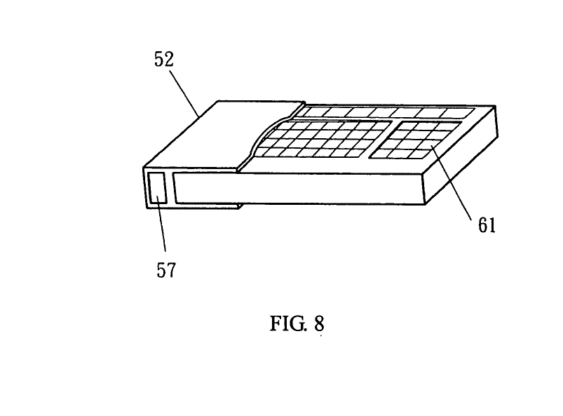

To illustrate the details of the keyboard storage case 52 according to the present invention, FIG. 7 provides a perspective view of the keyboard storage case wherein there is provided a lock structure 58 on the covering surface 55 of the keyboard storage case 52. The lock structure 58 located at the rear end portion of the covering surface 55 of the keyboard storage case 52 is used to latch the tablet computer main body 51 while the tablet computer main body 51 overlays on the keyboard storage case 52. There is also provided an inner room space 71 for storing the keyboard 61 shown in FIG. 6. As shown in FIG. 8, the inner room space 71 of the keyboard storage case 52 has a room size corresponding to the keyboard 61 for storing the keyboard 61. Furthermore, the inner room space 71 usually includes a latch mechanism structure to hook the keyboard 61 while the keyboard 61 is stocked in the inner room space 71. On the contrary, the keyboard 61 can be pulled out by pressing the push rod 57 positioned on one side of the keyboard storage case 52 as shown in FIG. 6.

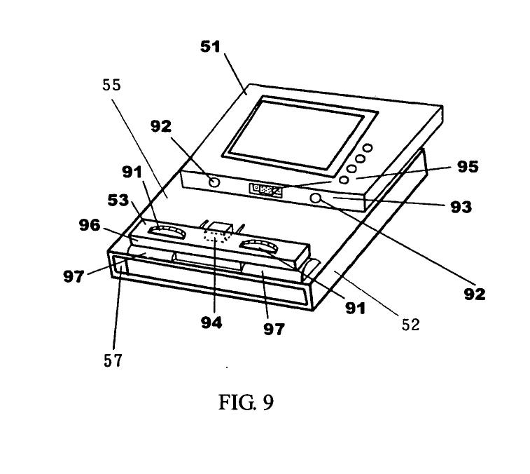

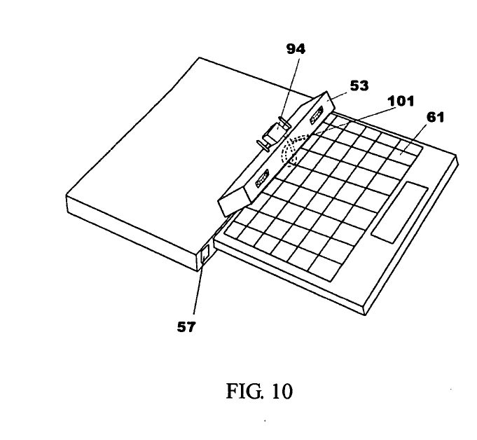

The hinge structure 53 is further disclosed in FIG. 9 and FIG. 10. FIG. 9 is a perspective view describing the hinge structure coupling the tablet computer main body with the surface of the keyboard storage case. In FIG. 9, the hinge structure 53 comprises a hinge abutment 96 locked by a hinge press member 97 to the covering surface 55 of the keyboard storage case 52. Therefore, the tablet computer main body 51 can not only be latched on the covering surface 55 of the keyboard storage case 52 but also be rotated so as the hinge abutment 96 can be moved downward or in contact with the covering surface 55 of the keyboard storage case 52. Moreover, the hinge structure 53 also comprises at least one lock structure 91, e.g. screw nuts, for being manually screwed the lock structure 91 to fasten the hinge structure 53 to the screw hole 92 located at the border 93 of the tablet computer main body 51. Furthermore, the hinge structure 53 comprises an electrical connection structure 94 coupling the electrical terminal structure 95 while the tablet computer main body 51 is latched by the lock structure 91. Referred to FIG. 10, there is provided an electrical line 1001 linked to the keyboard 61 for providing an electrical connection between the keyboard 61 and the tablet computer main body 51.

Although the invention is illustrated and described herein as embodiments above, it is nevertheless not intended to be limited to the details shown, since various modifications and structural changes may be made therein without departing from the spirit of the invention and within the scope and range of the claims. The scope of the invention is set forth in the following claims.

What is claimed is:

1. A tablet computer apparatus, comprising:
a computer main body comprising a tablet displaying unit;
a keyboard storage case comprising a inner room space for stocking a keyboard; and
a hinge structure arranged along a covering surface of the keyboard storage case for coupling a outer periphery of the computer main body with the keyboard storage case.

2. A tablet computer according to claim 1, wherein the tablet displaying unit is a display structure with a flat panel or a touch screen panel.

3. A tablet computer according to claim 1, wherein the outer periphery of the tablet displaying unit comprises at least one control key.

4. A tablet computer according to claim 1, wherein the keyboard storage case comprises an inner room space corresponding to the size of the keyboard.

5. A tablet computer according to claim 1, wherein the keyboard storage case comprises a latch mechanism structure to hook the keyboard while the keyboard is stocked in the inner room space.

6. A tablet computer according to claim 1, wherein the hinge structure comprises an electrical connection structure for coupling the computer main body with the keyboard.

7. A tablet computer according to claim 1, wherein the hinge structure comprises at least one lock structure for coupling the computer main body with the outer periphery of the hinge structure.

8. A tablet computer according to claim 7, wherein the lock structure is a screw nut.

9. A tablet computer according to claim 1, wherein the hinge structure comprises a hinge press member coupling with the covering surface of the keyboard storage case.

10. A keyboard storage case of a tablet computer apparatus for storing a keyboard, comprising:
a storage case comprising an inner room space for stocking a keyboard; and
a hinge structure arranged on the covering surface of the storage case coupling the tablet computer apparatus with the storage case.

11. A keyboard storage case according to claim 10, wherein the tablet computer apparatus comprises a tablet display unit and a computer main body.

12. A keyboard storage case according to claim 10, wherein the storage case comprises a lock structure located at the rear end portion of the covering surface of the keyboard storage case.

13. A keyboard storage case according to claim 11, wherein the tablet display unit is a display structure with a flat panel or a touch screen panel.

14. A keyboard storage case according to claim 11, wherein the outer periphery of the tablet displaying unit comprises at least one control key.

15. A keyboard storage case according to claim 10, wherein the keyboard storage case comprises an inner room space corresponding to the size of the keyboard.

16. A keyboard storage case according to claim 10, wherein the keyboard storage case comprises a latch mechanism structure to hook the keyboard while the keyboard is stocked in the inner room space.

17. A keyboard storage case according to claim 10, wherein the hinge structure comprises an electrical connection structure for coupling the computer main body with the keyboard.

18. A keyboard storage case according to claim 10, wherein the hinge structure comprises at least one lock structure for coupling the computer main body with the outer periphery of the hinge structure.

19. A keyboard storage case according to claim 18, wherein the lock structure is a screw nut.

20. A keyboard storage case according to claim 10, wherein the hinge structure comprises a hinge press member coupling with the covering surface of the keyboard storage case.
